(19) United States
(12) Patent Application Publication
(10) Pub. No.: US 2011/0094761 A1
(43) Pub. Date: Apr. 28, 2011

(54) PORTABLE BRUSHFIRE PROTECTION SYSTEM

(76) Inventor: Frederic Bollens, La Mesa, CA (US)

(21) Appl. No.: 12/764,941

(22) Filed: Apr. 21, 2010

Related U.S. Application Data
(60) Provisional application No. 61/171,325, filed on Apr. 21, 2009.

(51) Int. Cl. A62C 27/00

(52) U.S. Cl. 169/52

(57) ABSTRACT

A portable fire fighting cart. A plurality of wheels are attached to the cart. A handle is also attached to the cart and is used for positioning the cart. A water pump is connected to the cart. A pump section inlet is connected to the pump and receives water from a water source. A hand held hose outlet is attached to the pump and allows an operator to connect a hand held hose to the pump. A rotatable sprinkler is attached to the cart and is connected to the pump via a sprinkler outlet. The fire fighting cart is positionable next to a water source and the sprinkler is adjustable so that it can be easily aimed in the direction of an approaching fire. In a preferred embodiment the fire fighting cart includes a pump section and a sprinkler section. The pump section and sprinkler section are separable so that the pump section can be easily placed near the water source and the sprinkler section can be placed optimally in the path of an approaching fire. In a preferred embodiment the water source is a swimming pool, pond, lake or water tank.

This application claims the benefit of Provisional Application No. 61/171,325, filed Apr. 21, 2009. The present invention relates to a portable brushfire fighting systems, and in particular, to portable brushfire protection systems for protecting property from an approaching brush fire and/or a nearby fire.

### BACKGROUND OF THE INVENTION

Year after year many residential properties are destroyed by forest fires or brushfires. It is ironic that many of the properties destroyed had a swimming pool in their backyard. During or after the fire season, it is common to see an aerial view of the location after the fact showing multiple houses destroyed to the ground by the fire. Still, many of their respective pools or ponds are filled abundantly with water.

Portable systems to protect homes and properties from fire are already on the market but because of their need for someone (i.e., the property owner) to physically operate them to fight a fire, they become obsolete when heavy smoke or red ambers are present or when heat becomes unbearable and especially when an order to evacuate is given by the authorities.

What is needed is a better portable brushfire protection system.

### SUMMARY OF THE INVENTION

The present invention provides a portable fire fighting cart. A plurality of wheels are attached to the cart. A handle is also attached to the cart and is used for positioning the cart. A water pump is connected to the cart. A pump section inlet is connected to the pump and receives water from a water source. A hand held hose outlet is attached to the pump and allows an operator to connect a hand held hose to the pump. A rotatable sprinkler is attached to the cart and is connected to the pump via a sprinkler outlet. The fire fighting cart is positionable next to a water source and the sprinkler is adjustable so that it can be easily aimed in the direction of an approaching fire. In a preferred embodiment the fire fighting cart includes a pump section and a sprinkler section. The pump section and sprinkler section are separable so that the pump section can be easily placed near the water source and the sprinkler section can be placed optimally in the path of an approaching fire. In a preferred embodiment the water source is a swimming pool, pond, lake or water tank.

### BRIEF DESCRIPTION OF THE DRAWINGS

FIG. 1 shows a side view of a preferred embodiment of the present invention.

FIG. 2 shows a top view of a preferred embodiment of the present invention.

FIGS. 3-4 show a preferred pump section and a preferred sprinkler section.

FIG. 5 shows a top view for connections for a preferred embodiment of the present invention.

FIG. 6 shows a side view for connections for a preferred embodiment of the present invention.

FIG. 7 shows a perspective view of a preferred embodiment of the present invention.

FIG. 8 shows a perspective view of another preferred embodiment of the present invention.

FIGS. 9 and 10 illustrate the utilization of a preferred embodiment of the present invention.

FIG. 11 shows another preferred embodiment of the present invention.

FIG. 12 shows another preferred embodiment of the present invention.

FIG. 13 shows a side view of a preferred embodiment of the present invention.

### DETAILED DESCRIPTION OF THE PREFERRED EMBODIMENTS

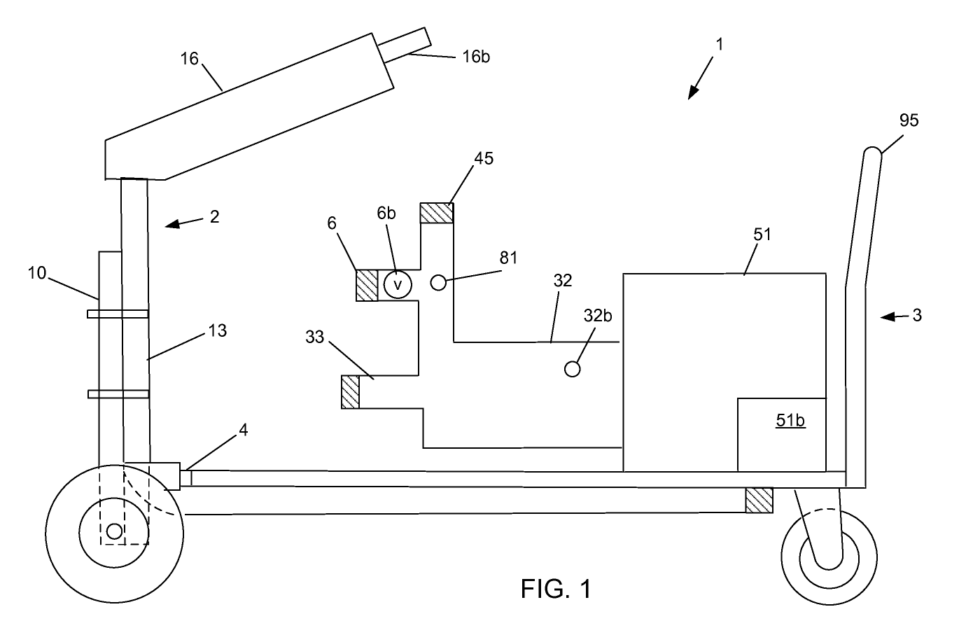

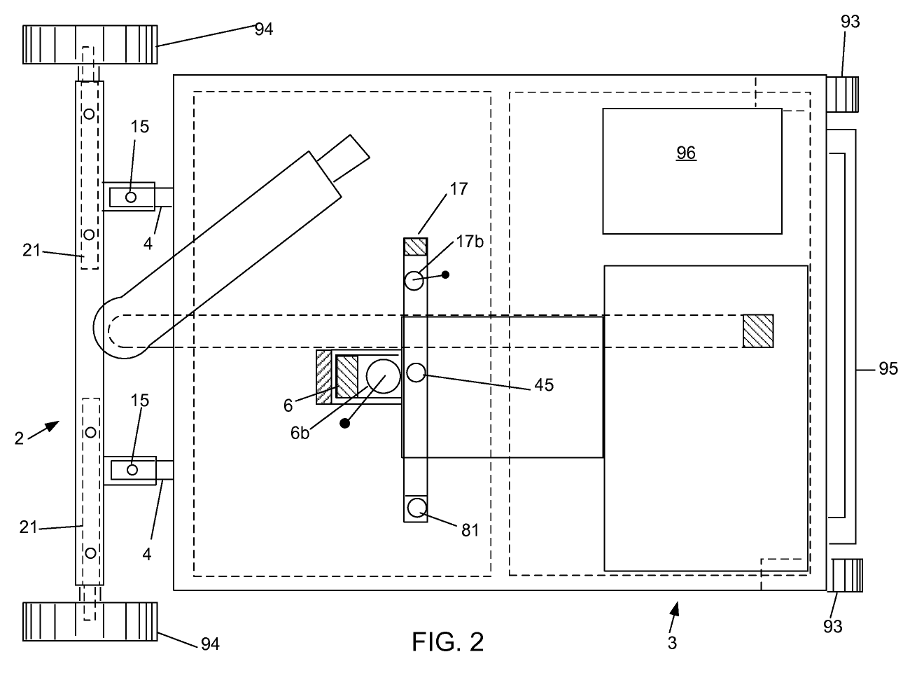

FIGS. 1 and 2 show simplified views and FIG. 8 shows a perspective view of fire fighting cart 1. Fire fighting cart 1 utilizes the considerable water source of a home swimming pool, or other large nearby water source, to fight a threatening brush fire. During a fire situation, using a pool, pond or an on location water tank is preferable and more dependable than the city water, as it is often shut down or will restrain water pressure for the firefighters needs.

Utilizing fire fighting cart 1 allows a home owner to protect himself and his property from a fire with a fast and easy system to deploy. Fire fighting cart 1 will drench a large area of the property and by doing so will either avoid its loss entirely or at least greatly increase the amount of protection for the property. When fire fighting cart 1 is placed near a water source and started, the owner has the choice to stay and fight the fire until determined unsafe to do so or leave the property and leave the system running.

Preferably, when a fire near the location of the property is detected and announced via a source of media or by the authorities, the owner will deploy fire fighting cart 1.

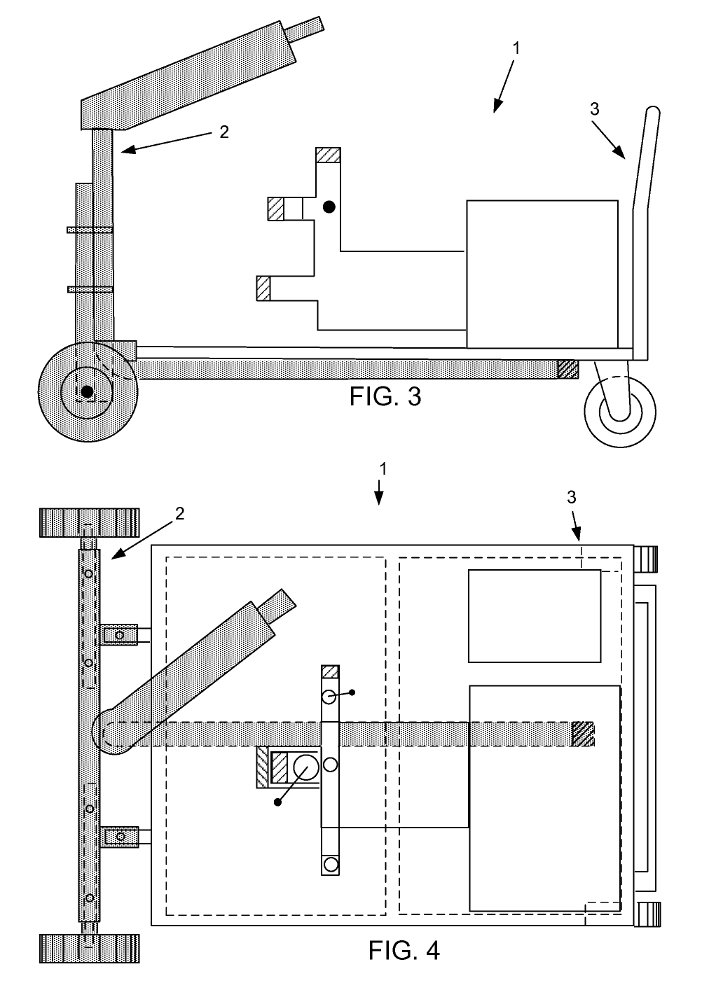

FIGS. 1-13 show preferred embodiments of the present invention. In a preferred embodiment, fire fighting cart 1 includes sprinkler section 2 and pump section 3. FIGS. 3 and 4 show sprinkler section 2 as being shaded for clarity. Gas Engine 51 is connected to pump section 3. Gas engine 51 includes gas tank 51b. Gas engine 51 powers high pressure centrifugal pump 32. A water hose for transferring water from a water source (pool, water shed, pond) connects to water inlet 33 of the pump 32. Safety pressure relief valve 81 is connected as shown. Pump primer inlet 45 allows for the priming of pump 32. Sprinkler water delivery outlet 6 allows water leaving pump 32 to connect to sprinkler 16 via double jacket fire hose 19. Interchangeable sprinkler nozzle 16b is connected to the end of rotatably attached sprinkler 16. Sprinkler pipe support 10 provides structural support for steel sprinkler tubing 13. Adjustable attachments 11 allow for the vertical adjustment of sprinkler tubing 13. Connection bars 4 with pins 15 allow for the connection of sprinkler section 2 to pump section 3. Pump section wheels 93 are rotatably connected to pump section 3 and sprinkler section wheels 94 are rotatably connected to sprinkler section 2. Cart handle 95 allows for easy hand controlled maneuvering of fire fighting cart 1. Optional 12V battery 96 is attached to pump section 3 and allows for an electric start of pump 32 if installed. It can also provide electric power as needed for other attached electrical devices. Hand held fire hose delivery outlet 17 is attached as shown and allows for connection to hand held fire hose for manual spray control ability. Wheel axles 21 allow for an expandable connection of wheels 94 for improved stability and for retractable connection of wheels 94 for improved maneuverability. Strainer 41 is attached to the end of hose 42 and prevents suction of large particulates from water source 92 to help prevent damage to pump unit 32. Hose 42 connects to pump 32 via water inlet 33. Double jacket hand operated fire hose 52 connects to fire hose delivery outlet 17. Fire hose nozzle 52b is attached to the end of fire hose 52 and allows for hand control of water stream leaving fire hose 52. Retractable legs 24 allow for support of pump section 3 when separated from sprinkler section 2.

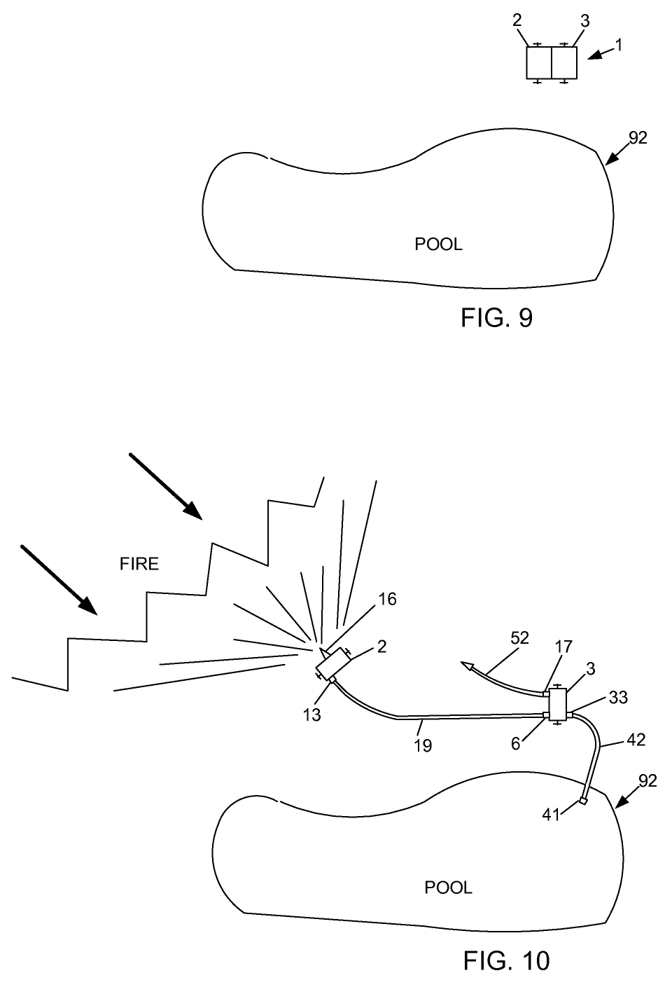

In a preferred embodiment, fire fighting cart 1 includes sprinkler section 2 and pump section 3. To utilize fire fighting cart 1, as shown in FIG. 9 the operator moves cart 1 from its storage location to the proximity of a water source 92 (pool, pond or water tank). At this point sprinkler section 2 and pump section 3 are secured to each other with drop-in pins 15 (FIG. 2) at connection bars 4 to form one easy to maneuver cart 1. When arrived at the water source location sprinkler section 2 and pump section 3 can be separated into two sub carts (FIG. 10 and FIG. 6). To do so, operator will first remove the two drop in pins securing the two retractable legs 24 of pump section 3 (FIG. 6). Leg extensions will drop until touching the ground and pins will be replaced to secure them. The operator will then remove drop in pins 15 from connection bars 4 between the sprinkler section 2 and pump section 3 and then pull away sprinkler section 2 from pump section 3.

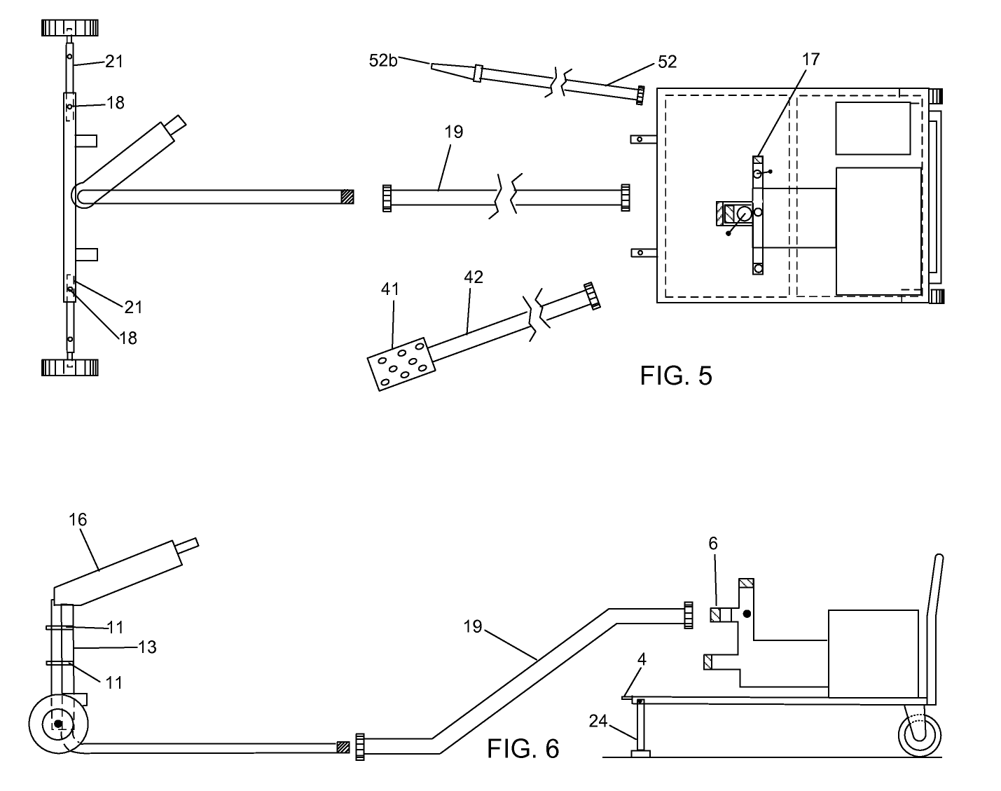

In a preferred embodiment, after it is separated sprinkler section 2 may be placed approximately 50 feet away from pump section 3 in the direction of the origin of the fire (FIG. 10). Both wheel axles 21 on sprinkler section 2 are then be extended out to their most outward position by removing and replacing two drop in pins 18 (FIG. 5). The two adjustable attachments 11 (FIG. 6) are then loosened to allow steel sprinkler tubing 13 holding rotatably attached sprinkler 16 to slide down and rest on the ground. Adjustable attachments 11 are then be tightened to hold sprinkler tubing 13 in this position during operation.

The adjustment of the sprinkler head rotation system allows for 360 degree rotation on sprinkler 16. The operator preferably limits sprinkler 16 rotation for the area to be wetted. The operator then connects the suction hose 42 to the water inlet 33 of the pump 32. The other end of suction hose 42 is dropped in the water source. Hand fire hose 52 is connected to hand fire hose delivery outlet 17. Sprinkler fire hose 19 is connected to pump delivery outlet 6 and sprinkler steel tubing 13 of the sprinkler section 2.

In a preferred embodiment, all hose connections are fire threaded for a quick and easy setup. For example, this allows for the fire department to connect their standard hoses to the hose connections of fire cart 1. Therefore, fire cart 1 is useful not only to the home owner, but also to the local fire department as well.

Prior to starting pump engine 51, the operator fills gas tank 5 lb and primes pump 32. To prime the pump, the operator will remove a cap on the pump primer inlet 45, pour one gallon of water and secure the cap back in place. In a preferred embodiment, at a relaxed pace it will take the operator less than 10 minutes for the entire setup.

Before starting engine 51, to provide flow to sprinkler 16 the operator will verify that delivery outlet ball valve 6b for sprinkler 16 is in the open position to allow flow up to sprinkler 16. Delivery outlet ball valve 17b for the hand fire hose will be in the closed position. Likewise, to allow flow to nozzle 52b, the operator will verify that delivery outlet ball valve 17b for hose 52 is in the open position to allow flow up to nozzle 52b. Delivery outlet ball valve 6b for sprinkler 16 will be in the closed position. Pump 32 is preferably started with the push of start button 32b if pump section 1 includes electric battery 96.

Once water starts flowing from the sprinkler nozzle 16 the operator will adjust the pump engine throttle for pump 32 to near its maximum to increase water flow and distance of the spray. In a preferred embodiment, taken from the center of the sprinkler nozzle, an area of approximately 135 feet radius or 270 feet diameter will then be wetted. In a preferred embodiment, the area will be wetted for approximately 2-2½ hours until the system runs out of gas or earlier depending on the volume of the water supply.

### Foam Nozzle Kit

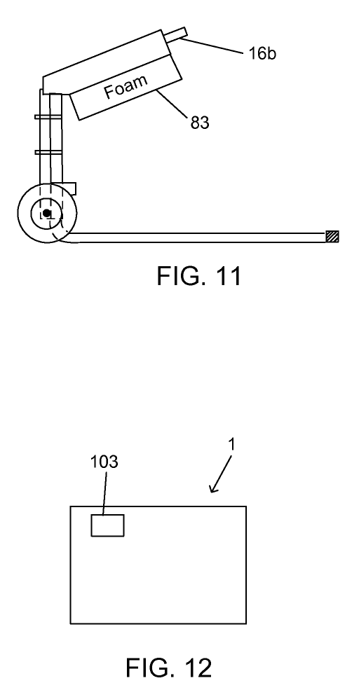

FIG. 11 shows another preferred embodiment utilizing foam nozzle kit 83. The utilization of foam nozzle kit 83 allows for the spraying of class “A” foam via nozzle 16b.

### Heat/High Temperature Detector

FIG. 12 shows heat/high temperature detector 103 attached to fire fighting cart 1. In this preferred embodiment, when heat/high temperature detector 103 detects heat or a high temperature, it will send a signal to gas engine 51 to start pump 32. Therefore, provided the hose connections have been appropriate made and there is an adequate source of water, fire fighting cart 1 will automatically start and run as needed.

### Hand Operated Pump for Priming Pump

Although it was described above how pump 32 is preferably primed via button 32b if pump section 3 includes electric battery 96, it would be possible to prime pump 32 via hand without the use of battery 96.

### Interchangeable Nozzles

Nozzles 16b and 52b can be interchangeable with various sized nozzles to be utilized depending on the needs of the operator.

### Sprinkler Head Permanently Mounted

Although it was shown above how sprinkler 16 is moveably mounted on sprinkler section 2, sprinkler 16 could be permanently mounted into concrete at a strategic place on the operator's property.

### Pump Section Permanently Mounted

Likewise, it is also possible to permanently mount pump section 3 into concrete at a strategic place on the operator's property. In this embodiment, suction hose 42 would preferably be coupled within the pool suction system already in place for water filtering.

### Sprinkler and Pump Attached to a Single Cart

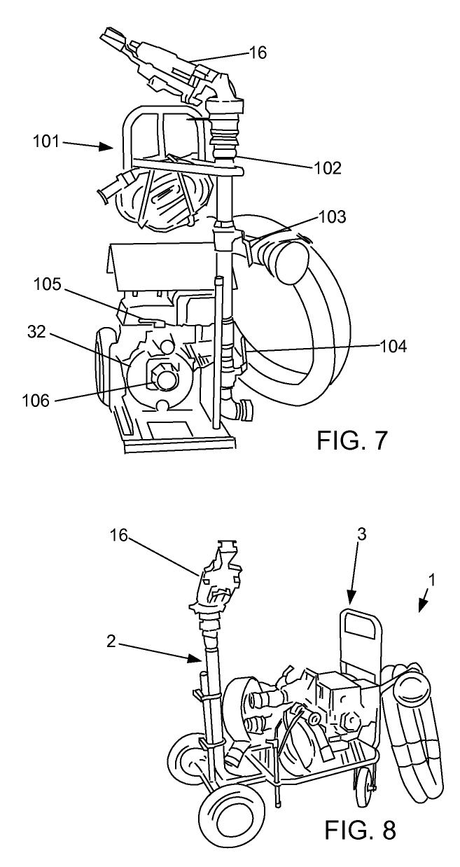

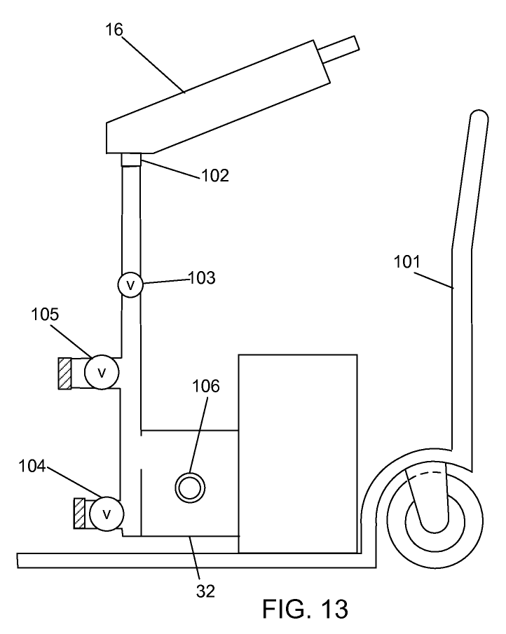

FIG. 7 shows a perspective view and FIG. 13 shows a simplified side view of cart 101. In cart 101 sprinkler 16 and pump 32 are both attached to the same cart 101. Rotatably attached sprinkler 16 is also preferably removably attached via quick disconnect 102. In this manner sprinkler head 16 can be used also in conjunction will optional sprinkler section 2 as desired by the operator. Flow control valve 103 controls flow to sprinkler 16. Flow control valve 104 controls the flow of water to an optional external sprinkler device, such as sprinkler 16 attached to sprinkler section 2 (see above embodiments) or a fire department sprinkler. Flow control valve 105 controls the flow of water to a hand held fire hose. Suction inlet 106 is connected via a suction hose to a water source. In this preferred embodiment, the user can control the flow of fire fighting water by utilizing flow control valves 103, 104, and 105 to allow the water to flow either to sprinkler 16 (via valve 103), to a hand held fire hose (via valve 105) or to an external sprinkler device (via valve 104).

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

What is claimed is:

1) A portable fire fighting cart comprising:
A) a plurality of wheels attached to said cart,
B) a handle for positioning said cart,
C) a pump attached to said cart,
D) a pump suction inlet for receiving water from a water source,
E) a hand held hose outlet attached to said pump for allowing an operator to connect a hand held hose to said pump,
F) a sprinkler rotatably connected to said cart
G) a sprinkler outlet attached to said pump for connecting said pump to said sprinkler,
wherein said portable fire fighting cart is maneuverable and positionable next to a water source, wherein said sprinkler is rotatably positionable so as to be aimable in the direction of approaching fire.

2) The portable fire fighting cart as in claim 1, further comprising:
A) a pump section, comprising pump section wheels, and
B) a sprinkler section wherein said sprinkler is attached to said sprinkler section, said sprinkler section comprising sprinkler section wheels, wherein said sprinkler section is removably connected to said pump section.

3) The portable fire fighting cart as in claim 2, wherein said sprinkler section is connected to said pump section via a hose.

4) The portable fire fighting cart as in claim 2, wherein said sprinkler section further comprises height adjustable sprinkler piping for adjusting the vertical height of said sprinkler.

5) The portable fire fighting cart as in claim 2, wherein said handle and said pump are connected to said pump section.

6) The portable fire fighting cart as in claim 2, wherein said sprinkler section wheels are expandably and retractably connected to said sprinkler section.

7) The portable fire fighting cart as in claim 2, wherein said pump section further comprises a plurality of support legs for supporting said pump section after the removal of removably attached sprinkler section.

8) The portable fire fighting cart as in claim 2 wherein said sprinkler section and said pump section are separated, wherein said pump suction inlet is receiving water from a water source via a water source hose, wherein said pump pumps water from said water source to said sprinkler section via a connection hose, wherein water is sprayed from said sprinkler towards a fire.

9) The portable fire fighting cart as in claim 8, wherein said hand held hose is connected to said pump via said hand held hose outlet.

10) The portable fire fighting cart as in claim 2, wherein said water source is a pool.

11) The portable fire fighting cart as in claim 2, wherein said water source is a pond.

12) The portable fire fighting cart as in claim 2, wherein said water source is a lake.

13) The portable fire fighting cart as in claim 2, wherein said water source is a water tank.

14) A portable fire fighting cart comprising:
A) a pump section, comprising pump section wheels, and
B) a sprinkler section comprising sprinkler section wheels, wherein said sprinkler section is removably connected to said pump section.
C) a handle attached to said pump section, said handle for positioning said cart,
D) a pump attached to pump section,
E) a pump suction inlet for receiving water from a water source,
F) a hand held hose outlet attached to said pump for allowing an operator to connect a hand held hose to said pump,
G) a sprinkler rotatably connected to sprinkler section
H) a sprinkler outlet attached to said pump for connecting said pump to said sprinkler,
wherein said portable fire fighting cart is maneuverable and positionable next to a water source, wherein said sprinkler is rotatably positionable so as to be aimable in the direction of approaching fire.

15) The portable fire fighting cart as in claim 14 wherein said sprinkler section and said pump section are separated, wherein said pump suction inlet is receiving water from a water source via a water source hose, wherein said pump pumps water from said water source to said sprinkler section via a connection hose, wherein water is sprayed from said sprinkler towards a fire.

16) The portable fire fighting cart as in claim 14, wherein said pump is gasoline powered.

17) The portable fire fighting cart as in claim 14, wherein said water source is a pool.

18) The portable fire fighting cart as in claim 14, wherein said water source is a pond.

19) The portable fire fighting cart as in claim 14, wherein said water source is a lake.

20) The portable fire fighting cart as in claim 14, wherein said water source is a water tank.
